(19) United States
(12) Patent Application Publication
(10) Pub. No.: US 2007/0270036 A1
(43) Pub. Date: Nov. 22, 2007

(54) High Speed Data Plug and Method for Assembly

(76) Inventors: Yakov Belopolsky, Harrisburg, PA (US); Brian Bentley, York, PA (US); David Gutter, Felton, PA (US); Richard Marowsky, York, PA (US); Steven Weller, Camp Hill, PA (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/748,665

(22) Filed: May 15, 2007

Related U.S. Application Data
(60) Provisional application No. 60/747,529, filed on May 17, 2006.

(51) Int. Cl. H01R 9/03

(52) U.S. Cl. 439/610

(57) ABSTRACT

A method and system for terminating a cable into a plug using a plug assembly system. Wires of the cable are exposed and dressed on to a shield. A plug body is placed over the shield. The wires are fed into wire insertion holes of the plug body. A contact holding member is placed on the plug body. A crimping tool crimps the contacts in the contact holding member through the plug body into and through the wires to achieve mechanical and electrical connection between the wires and the contacts. A cover may be used to cover the plug body, shield and wires. A crimp ferrule may be used to crimp the wires to the shield.

This application claims priority to provisional application No. 60/747,529 entitled “HIGH SPEED DATA PLUG AND METHOD FOR ASSEMBLING SAME” filed May 17, 2006, the entirety of which is hereby incorporated by reference.

### BACKGROUND OF THE INVENTION

The invention relates to a modular plug and, more particularly, to a modular plug design which can accommodate Category 7 communications and which may be easily assembled.

The use of modular plugs and jacks for data transmission is known. Basically, in order to establish electrical communication and a data path between a first and second device, the first device may send information in the form of electrical signals into a cable that terminates in a plug. The second device may include a jack. The plug and jack are designed so as to be easily mechanically mate-able in a male-female configuration. Once the plug and jack are mated, electrical members in the plug and jack engage and are electrically mated so that electrical information signals may travel from the first device to the second device.

This plug and jack design is limited by the physical configuration of the modular plug and jack. As data transmission speeds have increased, electrical performance relating to the transfer of electrical signals from plug to jack, has been affected. Each plug and jack frequently includes multiple pairs of contacts used to communicate information. Cross talk between these pairs (where electrical signals in one pair affect electrical signals in another pair) and interference from sources external to the plug-jack configuration, become more of a factor at higher speeds. In order to transmit higher speed data while minimizing signal degradation, the plug and jack design changed from prior designs to include extra shielding.

Standards organizations such as the Telecommunication Industry Association and the International Organization for Standardization publish standards regarding performance specifications and equipment configurations for plugs and jacks. Different levels or “categories” have been defined for use in twisted-pair cabling such as where a single insulated sheath includes two twisted wires. For example, “Category 6” plugs and jacks should be able to handle data communications with a frequency up to 250 MHz. Category 6 plugs and jacks typically have eight contacts aligned in a row on exclusively either a top or bottom of the plug or jack. More recent requirements, e.g. Category 7, require plugs and jacks which can communicate at speeds as high as 600 MHz. To handle these data communication speeds, Category 7 plugs are designed to have contact pairs on both the top and bottom of the plug body in contrast with the eight contacts all on either a top or bottom as in Category 6 plugs and jacks.

In practice, a technician terminates a cable having wires disposed therein, with a modular plug. When dealing with slower speed communication such as Category 6, where contacts are all aligned on a single side of a plug, assembly of such a plug to a cable was fairly simple. However, prior art methods for meeting the requirements of Category 7 standards for modular plugs requires use of complex contact formations, extensive shielding and multiple housing components. Further, in prior art techniques, contacts of the plug are mated with the wires in the cable through use of a small pyramidal shaped pin which is pushed through the respective insulated wires of the cable. Such a connection is not reliable in that over time the pin may recede from the wires, or wire strands of the wires may move and the contact forces between pin and wires can degrade resulting in high resistance, intermittent connections.

### SUMMARY OF THE INVENTION

One embodiment of the invention is a method for assembling a plug, the method comprising exposing wires in a cable, dressing at least one of the wires on a top of a shield and placing a plug body over the shield. The method further comprises placing a contact holder including contacts over the plug body and crimping the contacts through the contact holder and the plug body into the wires.

Another embodiment of the invention is a plug assembly system comprising a contact holder including contacts and a plug body combinable with the contact holder, the plug body including recesses aligned with the contacts when the plug body is combined with the contact holder. The plug assembly system further comprises a shield having a top and a bottom and shaped so that the plug body may be placed over the shield.

### BRIEF DESCRIPTION OF THE DRAWINGS

FIG. 1 is a top perspective view of a plug assembly system and cable in accordance with an embodiment of the invention.

FIG. 2 is a top perspective view of a plug assembly system and cable in accordance with an embodiment of the invention.

FIG. 3 is a top perspective cut-away view of wires dressed on a shield pierced with contacts in accordance with an embodiment of the invention.

FIG. 4 is a top perspective exploded view of a contact holder and contacts in accordance with an embodiment of the invention.

FIG. 5 is a top perspective view of a contact holder with contacts in accordance with an embodiment of the invention.

FIG. 6 is a top perspective view of a plug assembly system and cable in accordance with an embodiment of the invention.

FIG. 7 is a top perspective view of a plug assembly system and cable in accordance with an embodiment of the invention.

FIG. 8 is a top perspective view of a plug assembly system and cable in accordance with an embodiment of the invention.

FIG. 9 is a top perspective view of a plug assembly system and cable in accordance with an embodiment of the invention.

FIG. 10 is a top perspective view of a plug assembly system and cable in accordance with an embodiment of the invention.

FIG. 11 is a top perspective view of a plug and cable terminated in accordance with an embodiment of the invention.

FIG. 12 is a bottom perspective view of a plug and cable terminated in accordance with an embodiment of the invention.

### DETAILED DESCRIPTION OF THE PREFERRED EMBODIMENT(S)

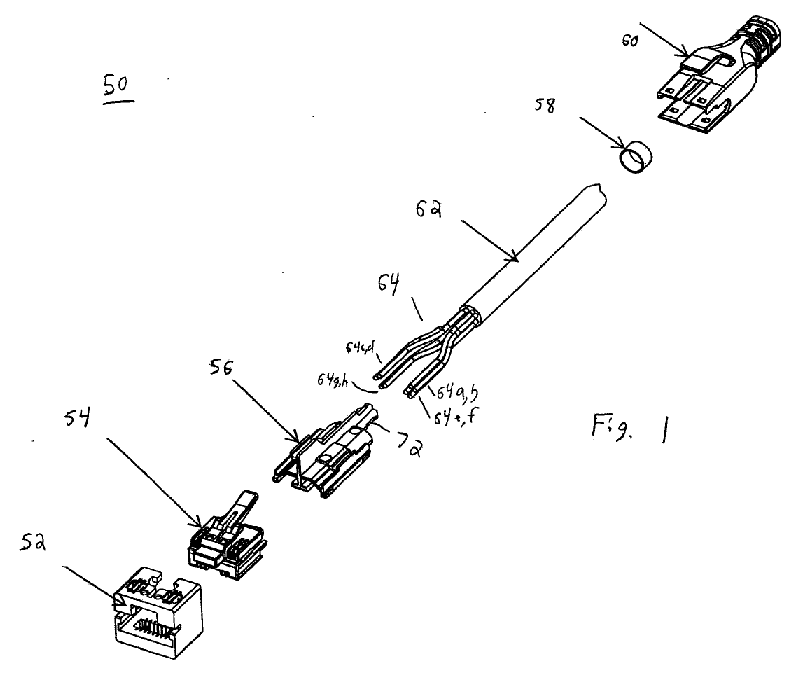

Referring to FIG. 1, there is shown a modular plug assembly system 50 in accordance with an embodiment of the invention. Plug assembly system 50 includes a contact holder member 52, a plug body 54, a shield 56, a crimp ferrule 58 and a strain relief boot or cover 60. When a user desires to terminate a cable 62 with a plug using plug assembly system 50, the user first feeds strain relief boot 60 over an end of cable 62. The user then opens or strips an outer sheathing of cable 62 and removes any foil shields around wires 64 to expose wires 64. In the figures, eight (8) wires 64a, 64b, 64c, 64d, 64e, 64f, 64g, and 64h are shown.

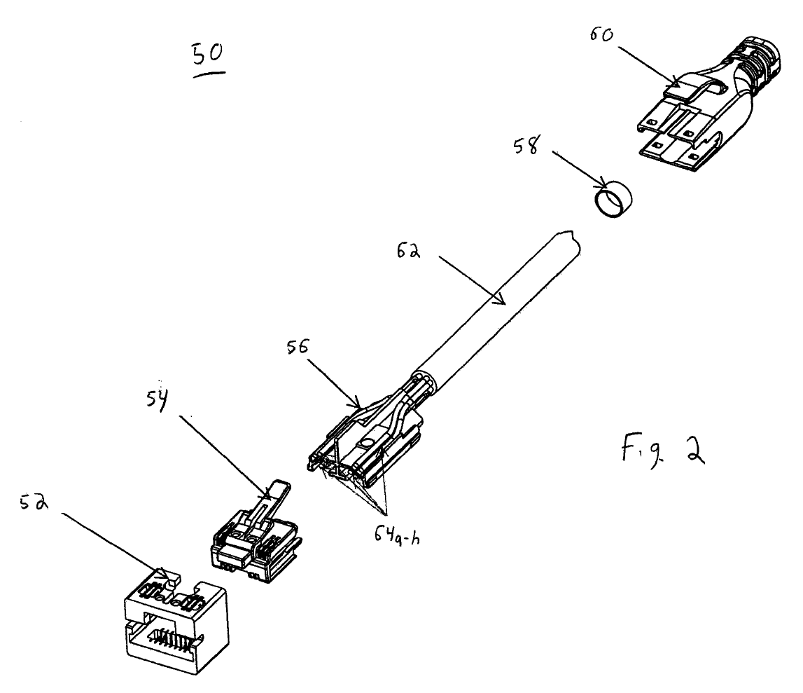

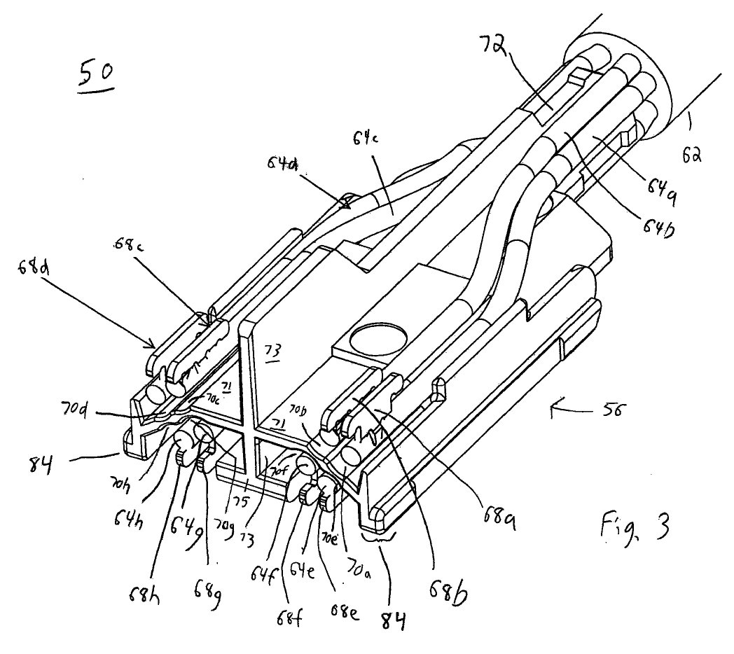

Referring to FIGS. 2 and 3, in cable 62, each of four twisted wire pairs 64a, 64b; 64c, 64d; 64e, 64f; 64g, 64h are disposed in individually wrapped foil shields (not shown). Two pairs of wires 64a, 64b and 64c, 64d are straightened and dressed, in channels 70a, 70b, 70c, 70d, respectively, on the top side of shield 56. Similarly, wire pairs 64e, 64f and 64g, 64h are dressed in channels 70e, 70f, 70g, 70h on the bottom side of shield 56. Shield 56 may include a key 84 at distal ends used in plugs communicating with particular types of communication standards such as Category 6 communications.

Shield 56 is used to prevent crosstalk between pairs of wires. Shield 56 includes a horizontally extending ribs 71, vertically extending ribs 73, a base 75, and a post 72 (post best shown in FIG. 1). Vertically extending ribs 73 shield wires 64a, 64b, from 64c, 64d and similarly shield wires 64e, 64f from 64g, 64h. Horizontally extending ribs 71 shield wires 64a, 64b from wires 64e, 64f and similarly shield wires 64c, 64d from wires 64g, 64h. Base 75 further shields wires 64e, 64f from 64g, 64h. Shield 56, thus shields virtually all portions of wires 64 not disposed within cable 62.

Horizontally extending ribs 71 initially extend perpendicular to vertically extending ribs 73 and then taper downwardly toward a bottom of the plug. Channels 70 are defined in the tapered portion of horizontally extending ribs 71 so that channels 70a and 70b are at different heights from one another, channels 70c, 70d are at different heights, channels 70e, 70f are at different heights, and channels 70g, 70h are at different heights. These differing heights mean that contacts 68 of different lengths are used.

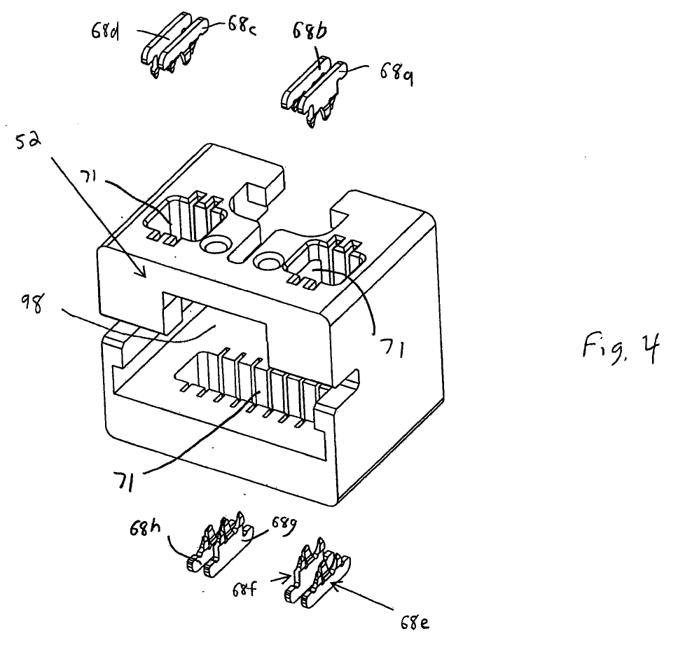

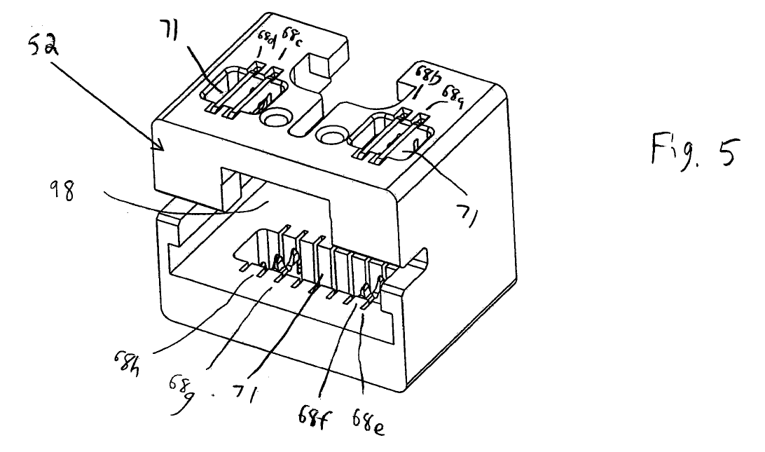

Referring to FIGS. 4 and 5, there is shown contact holder member 52 holding contacts 68. As discussed immediately above, contacts 68 have differing lengths so as to effectively mate with wires 64 disposed in channels 70 of differing heights. For example, contacts 68a, 68d, 68f, and 68g are longer than contacts 68b, 68c, 68e, and 68h. Clearly, shield 56 may be designed without such differing heights of channels or with channels heights having other configurations suggesting use of other contact lengths. Contact holder member 52 includes apertures 71 for receiving contacts 68 therein. Contact holder 52 may include a cut-out 98 effective to receive and mate with a protrusion or plug body 54 as in discussed below.

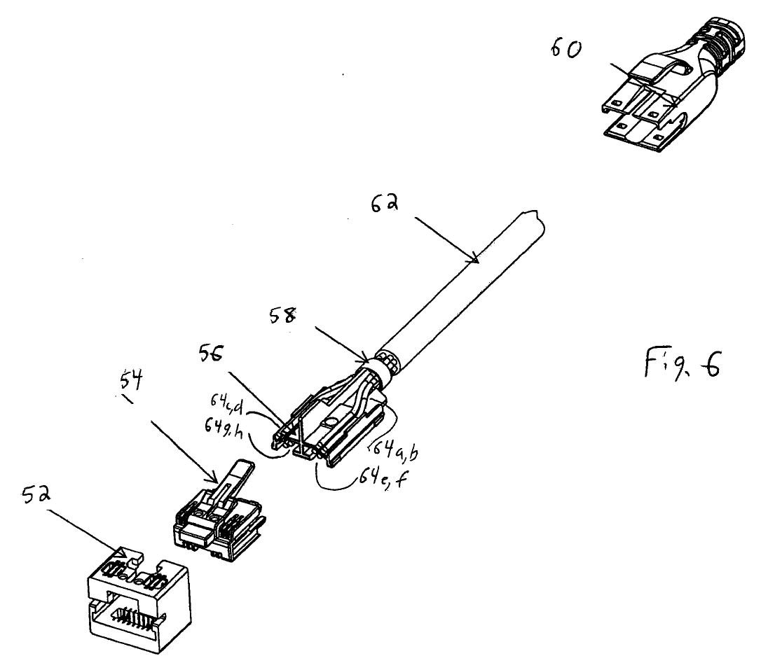

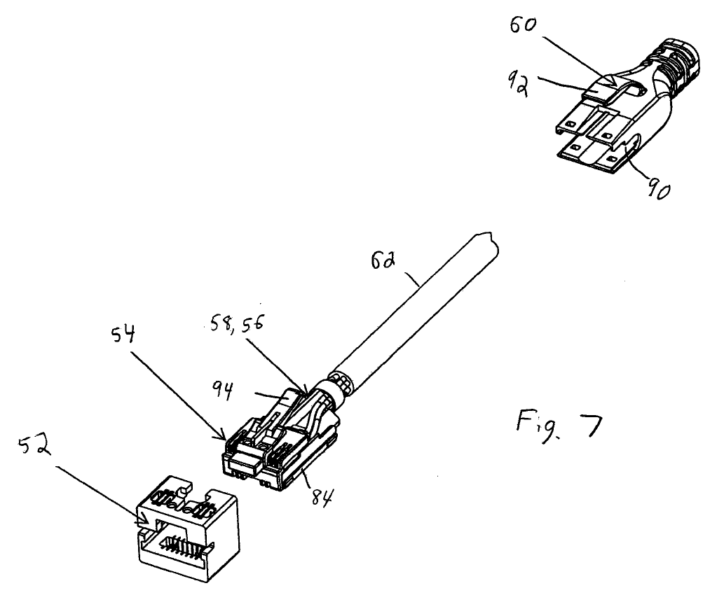

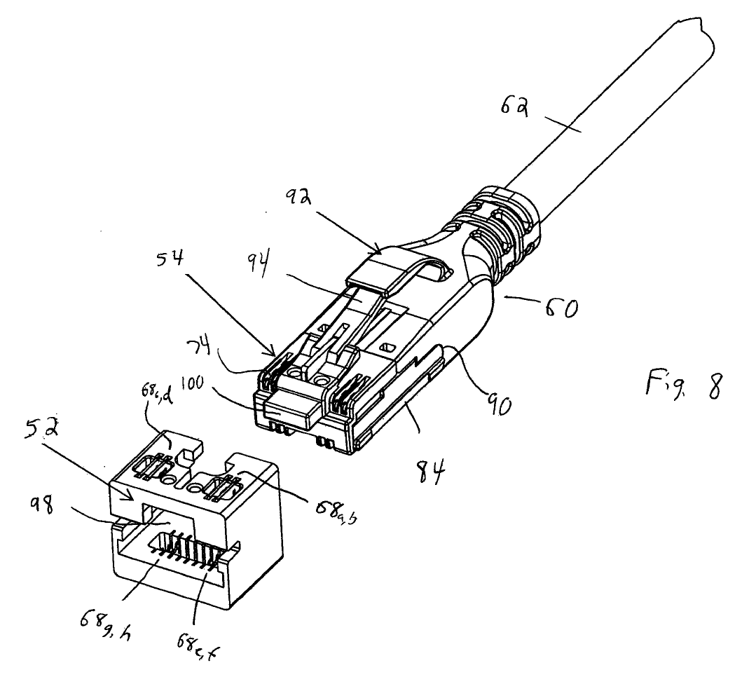

Referring now to FIG. 6, when terminating a cable, wires 64 in cable 62 are dressed and cut off flush with an end of shield 56. Once wires 64 are dressed on shield 56, crimp ferrule 58 is crimped onto post 72 (FIG. 1) of shield 56 to secure wires 64 to shield 56. Thereafter, plug body 54 is placed over shield 56 as shown in FIG. 7. Wires 64 are inserted into wire insertion holes (not shown) of plug body 54. Cover 60 is then slid over plug body 54 (FIG. 8). As shown, a groove 90 on cover 60 mates with key 84 on plug body 54. Further, a latch 92 on cover 60 engages a tab 94 on body 54 so as to facilitate secure engagement between cover 60 and body 54. Tab 94 also provides mechanical engagement between plug 50 and a jack (not shown). Depressing latch 92 releases tab 94 from the jack.

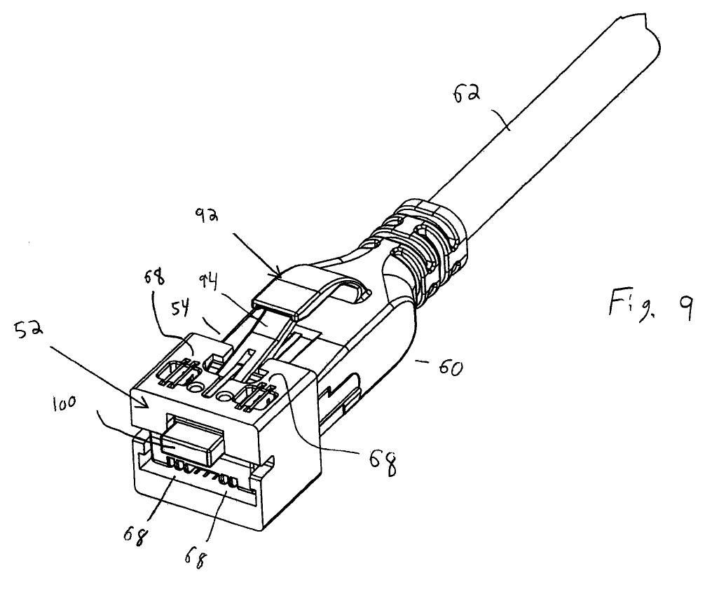

Referring to FIG. 9, contact holder member 52, retaining pre-inserted contacts 68 is then placed over plug body 54 and the combination of these two elements is then assembled over wires 64 and shield 56. A protrusion 100 of plug body 54 mates with cut-out 98 of contact holder 52. As discussed, contact holder 52 includes eight (8) contacts 68a, 68b, 68c, 68d, 68e, 68f, 68g, 68h disposed on a top and a bottom of contact holder 52 respectively. Plug body 54 includes corresponding recesses or slots 74 (see FIG. 8) aligned with contacts 68 when contact holder 52 is placed over plug body 54. Though eight contacts and recesses are shown, clearly any other number of contacts and recesses may be used. For example, if plug assembly system 50 is also to be used for a plug that is to be Category 6 compliant, 12 contacts may be used—4 on a top and 8 on a bottom or 8 on a top and 4 on a bottom.

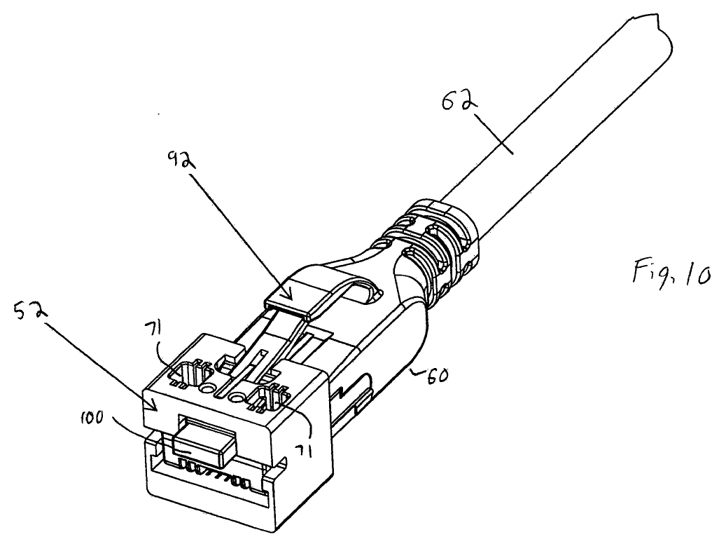

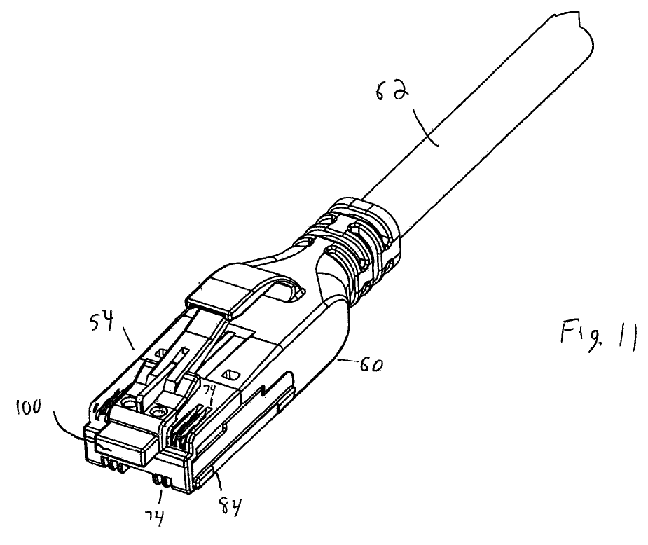

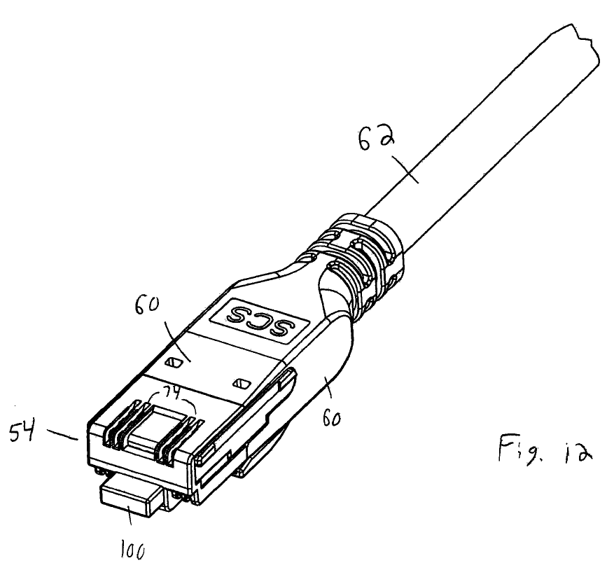

Referring to FIGS. 3, 9 and 10, the assembly of a plug then includes a crimping or driving of contacts 68 through contact holder 52 into plug body 54, into channels 70 and then through wires 64. The crimping may be done by a piston using a hand tool or work bench tool (not shown) and provides both a mechanical and electrical connection between contacts 68 and wires 64. Tines of contacts 68 penetrate any insulation of wires 64. Once the crimping is performed, and contacts 68 previously retained in contact holder 52 are inserted into plug body 54 to terminate wires 64, contact holder 52 is detached from plug body 54 and discarded. The views shown in FIGS. 11 and 12 show plug body 54 after contact holder 52 has been discarded. In prior art assemblies, contacts were frequently pre-inserted in the plug body itself. Such an arrangement is very difficult to use in high speed Category 7 plugs where contacts are disposed on both sides of a plug.

Having described the preferred embodiments of the invention, it should be noted that the scope of the invention is limited only by the scope of the claims attached hereto and obvious modifications may be made without departing from the scope and spirit of the invention.

What is claimed is:

1. A method for assembling a plug, the method comprising:
exposing wires in a cable;
dressing at least one of the wires on a top of a shield;
placing a plug body over the shield;
placing a contact holder including contacts over the plug body; and
crimping the contacts through the contact holder and the plug body into the wires.

2. The method as recited in claim 1, wherein:
the dressing includes dressing at least two wires; and
the shield includes a top vertically extending rib disposed so as to shield wires placed on the top of the shield and placed on distinct sides of the top vertically extending rib.

3. The method as recited in claim 2, further comprising:
dressing at least two wires on a bottom of the shield; and wherein
the shield includes a bottom vertically extending rib disposed so as to shield wires placed on the bottom of the shield and placed on distinct sides of the bottom vertically extending rib.

4. The method as recited in claim 3, wherein four wires are dressed on the top of the shield and four wires are dressed on the bottom of the shield.

5. The method as recited in claim 1, further comprising placing a cover over the plug body.

6. The method as recited in claim 1, wherein the shield further includes a post and the method further comprises crimping a ferrule on to the wires and on to the post.

7. The method as recited in claim 1, wherein the shield includes a key at distal ends thereof.

8. The method as recited in claim 3, wherein the shield includes at least one horizontally extending rib disposed so as to shield a wire placed above the horizontally extending rib from a wire placed below the horizontally extending rib.

9. The method as recited in claim 8, wherein:
the horizontally extending rib is tapered downwardly so that wires disposed on the top of the shield are disposed at differing heights and wires disposed on the bottom of the shield are disposed at differing heights.

10. The method as recited in claim 9, wherein the contacts in the contact holder include contacts of at least two lengths.

11. The method as recited in claim 1, further comprising removing the contact holder from the plug body.

12. A plug assembly system comprising:
a contact holder including contacts;
a plug body combinable with the contact holder, the plug body including recesses aligned with the contacts when the plug body is combined with the contact holder; and
a shield having a top and a bottom and shaped so that the plug body may be placed over the shield.

13. The plug assembly system as recited in claim 12, wherein:
the shield further includes a post and the system further comprises a ferrule effective to be crimped around the post.

14. The plug assembly system as recited in claim 12, further comprising a cover effective to cover at least a portion of the shield and the plug body.

15. The plug assembly system as recited in claim 12, wherein:
the shield further includes a top vertically extending rib disposed so as to shield wires placed on the top of the shield and placed on distinct sides of the top vertically extending rib.

16. The plug assembly system as recited in claim 15, wherein:
the shield includes a bottom vertically extending rib disposed so as to shield wires placed on the bottom of the shield and placed on distinct sides of the bottom vertically extending rib.

17. The plug assembly system as recited in claim 12, wherein the shield includes a key at distal ends thereof.

18. The plug assembly system as recited in claim 16, wherein the shield includes at least one horizontally extending rib disposed so as to shield a wire placed above the horizontally extending rib from a wire placed below the horizontally extending rib.

19. The plug assembly system as recited in claim 18, wherein:
the horizontally extending rib is tapered downwardly so that wires disposed on the top of the shield are disposed at differing heights and wires disposed on the bottom of the shield are disposed at differing heights.

20. The plug assembly system as recited in claim 19, wherein the contacts in the contact holder include contacts of at least two lengths.
